(19) United States
(12) Patent Application Publication
(10) Pub. No.: US 2017/0076325 A1
(43) Pub. Date: Mar. 16, 2017

(54) SIMPLIFIED NEXT GENERATION SHOPPING EXPERIENCE

(71) Applicant: International Business Machines Corporation, Armonk, NY (US)

(72) Inventors: Sheshnarayan Agrawal, Bangalore (IN); Sriram K. Padmanabhan, San Jose, CA (US)

(21) Appl. No.: 14/982,032

(22) Filed: Dec. 29, 2015

Related U.S. Application Data
(63) Continuation of application No. 14/854,577, filed on Sep. 15, 2015.

(51) Int. Cl. G06Q 30/02; G06Q 30/06

(52) U.S. Cl. CPC G06Q 30/0255; G06Q 30/0261; G06Q 30/0633

(57) ABSTRACT

An indication of a user is received. The indication includes at least one of the following: an indication that the user is within a pre-determined proximity of the retail store; an indication that the user has entered the retail store; or an indication that the user has entered a retail store and logged into a program. A special offer is sent to the user. A completed order from the user is received.

### BACKGROUND OF THE INVENTION

The present invention relates generally to the field of shopping, and more particularly to simplifying the next generation shopping experience.

Shopping is an activity most everyone participates in, at least to some degree. To facilitate shopping, we sometimes create a shopping list. To save money, we sometimes look for discount coupons or other offers. Sometimes, we shop from the comfort of our own homes while other times, we leave our homes to visit a bricks and mortar store to do our shopping. In either case, we pay for the items we wish to purchase and proceed to get them home by physically taking them ourselves or for arranging delivery.

### SUMMARY

Embodiments of the present invention include a method, computer program product, and system for simplifying the next generation shopping experience. In one embodiment, an indication of a user is received. The indication includes at least one of the following: an indication that the user is within a pre-determined proximity of the retail store; an indication that the user has entered the retail store; or an indication that the user has entered a retail store and logged into a program. A special offer is sent to the user. A completed order from the user is received.

### BRIEF DESCRIPTION OF THE DRAWINGS

FIG. 1 is a functional block diagram of a computing environment, in accordance with an embodiment of the present invention;

FIG. 2 is a flowchart depicting operational steps of a program that functions to simplify the next generation shopping experience, in accordance with an embodiment of the present invention; and

FIG. 3 depicts a block diagram of the components of a computing system representative of the user device, store server, and distribution server of FIG. 1, in accordance with an embodiment of the present invention.

### DETAILED DESCRIPTION

Some embodiments of the present invention recognize that a shopping trip may be hectic and frustrating. Stores are over-crowded and checkout lines are long and occupied by people with short tempers. The entire shopping experience leaves one wishing for a better way since shopping is an activity most people need to periodically do.

Embodiments of the present invention recognize that there may be a better way to carry out a shopping trip. Imagine if a shopper could load the inventory of a store onto an electronic device, create a shopping list, select items and quantities of those items from the shopping list, receive and accept special offers for items being purchased, pay for the purchased items, and have the purchased items packaged and waiting for the shopper to pick up at a location determined by the shopper. Such a method for shopping may be realized by utilizing a program to simplify the next generation shopping experience.

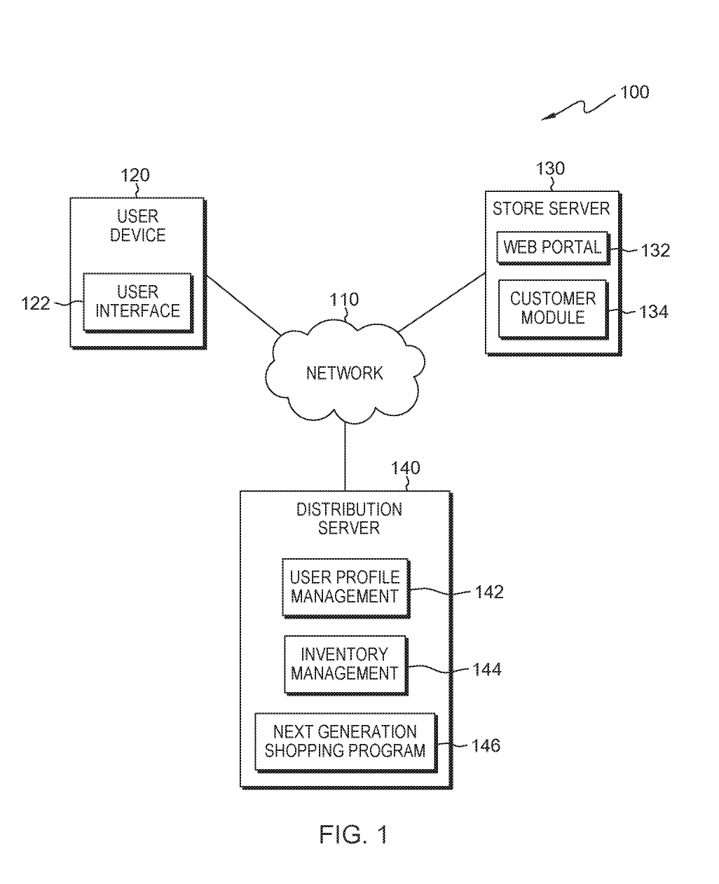

The present invention will now be described in detail with references to the Figures. FIG. 1 is a functional block diagram of a computing environment, generally designated 100, in accordance with an embodiment of the present invention. FIG. 1 provides only an illustration of one implementation and does not imply any limitations with regard to the environments in which different embodiments may be implemented. Those skilled in the art may make many modifications to the depicted environment without departing from the scope of the invention as recited by the claims.

An embodiment of computing environment 100 includes user device 120, store server 130, and distribution server 140, interconnected over network 110. In an example embodiment, utilizing network 110, user device 120 may communicate with store server 130, and/or may communicate with distribution server 140. In example embodiments, computing environment 100 may include other computing devices not shown such as smartwatches, cell phones, smartphones, phablets, tablet computers, laptop computers, desktop computers, other computer servers or any other computer system known in the art.

In example embodiments, user device 120, store server 130, and distribution server 140 may connect to network 110 which enables user device 120, store server 130, and distribution server 140 to access other computing devices and/or data not directly stored to user device 120, store server 130, and distribution server 140. Network 110 may be a local area network (LAN), a telecommunications network, a wide area network (WAN) such as the Internet, or any combination of the three, and include wired, wireless or fiber optic connections. Network 110 may include one or more wired and/or wireless networks that are capable of receiving and transmitting data, voice, and/or video signals, including multimedia signals that include voice, data, and video information. In general, network 110 can be any combination of connections and protocols that will support communications between user device 120, store server 130, distribution server 140, and other computing devices (not shown) within computing environment 100, in accordance with embodiments of the present invention.

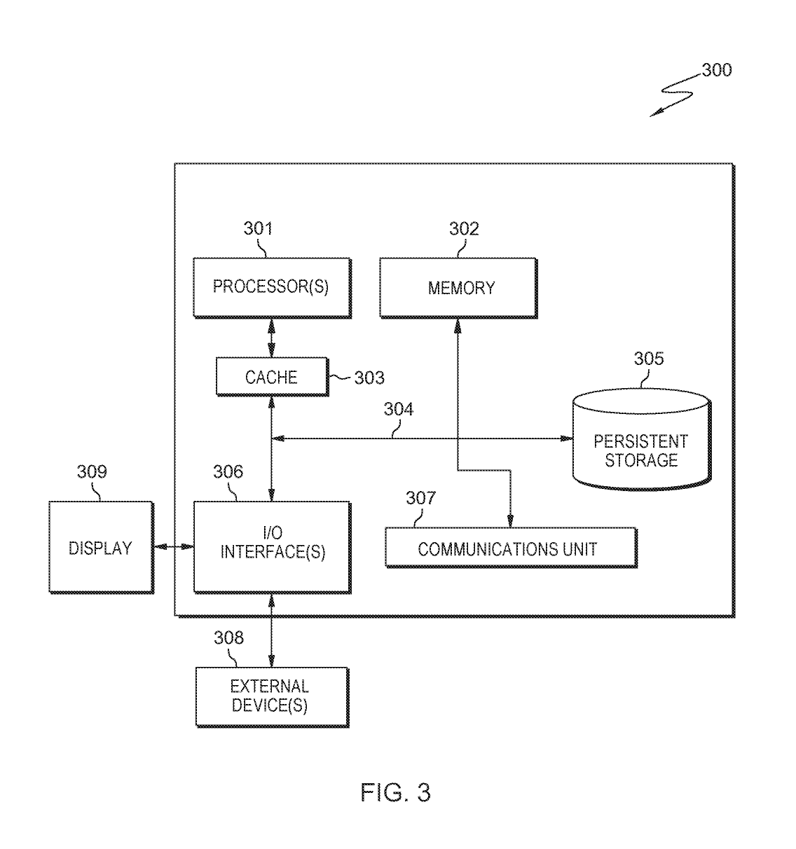

In various embodiments of the present invention, user device 120 may be a laptop, tablet or netbook personal computer (PC), a desktop computer, a personal digital assistant (PDA), a smartphone, or any other hand-held, programmable electronic device capable of communicating with any computing device within computing environment 100. In certain embodiments, user device 120 represents a computer system utilizing clustered computers and components (e.g., database server computers, application server computers, etc.) that act as a single pool of seamless resources when accessed by elements of computing environment 100 (e.g., store server 130 and distribution server 140). In general, user device 120 is representative of any electronic device or combination of electronic devices capable of executing computer readable program instructions. Store server 130 and distribution server 140 are substantially similar to user device 120 and have substantially similar components. User device 120, store server 130, and distribution server 140 may include components as depicted and described in further detail with respect to FIG. 3, in accordance with embodiments of the present invention.

According to embodiments of the present invention, user device 120 includes user interface 122. In addition to user interface 122, user device 120 includes other functions (not shown) such as the following: an image device; a data repository; a web browser; etc.

In example embodiments, user interface 122 provides an interface between a user of user device 120 and any other devices connected to network 110 such as store server 130 and distribution server 140. User interface 122 allows a user of user device 120 to interact with Next Generation Shopping (NGS) Program 146 and also enables the user to receive an indicator of one or more previous viewing locations and a summary of viewing history. In general, a user interface is the space where interactions between humans and machines occur. User interface 122 may be a graphical user interface (GUI) or a web user interface (WUI) and can display text, documents, web browser windows, user options, application interfaces, and instructions for operation, and include the information (such as graphic, text, and sound) that a program presents to a user and the control sequences the user employs to control the program. User interface 122 may also be mobile application software that provides an interface between a user of user device 120 and network 110. Mobile application software, or an “app,” is a computer program designed to run on smartphones, phablets, tablet computers and other mobile devices.

According to embodiments of the present invention, store server 130 includes web portal 132 and customer module 134. Additionally, store server 130 includes functions (not shown) such as the following: an employee database; tracking employee hours worked; payroll calculation; advertising; sales history; backup for distribution server 140; etc. In an alternative embodiment, web portal 132 and customer module 134 may be found on any other devices connected to network 110.

In example embodiments, web portal 132 may be a program, subprogram of a larger program, application, plurality of applications or mobile application software which provides an internet based interface to NGS Program 146. Mobile application software, or an “app,” is a computer program designed to run on smartphones, phablets, tablet computers, other mobile devices, laptop computers, desktop computers, etc. Web portal 132 allows a user to access NGS Program 146 without physically being at the store location. The user may access web portal 132 via a smartphone, tablet/laptop/desktop computer, or any other electronic device capable of connecting to the internet (i.e., user device 120). In an embodiment of the present invention, a user may create a shopping list for an upcoming shopping trip, may review past transactions to see what items were purchased in what quantities, may review transaction history for budgetary purposes, and may see what special offers are currently available to the user via web portal 132. A user may also update a profile (e.g., change an e-mail address or update credit card information) from web portal 132. In general, all features of NGS Program 146 that may be accessed by the user when physically in the store may be accessed via web portal 132.

In an embodiment of the present invention, customer module 134 is a program, subprogram of a larger program, application or plurality of applications which provides an interface between store personnel and a user of NGS Program 146. Store personnel may be employees that use store server 130, that serve as cashiers, that retrieve purchased items (i.e., items in the shopping cart of a buyer, that deliver the purchased items to the buyer, or provide other store functions. In various embodiments, customer module 134 allows store personnel to receive a completed “shopping cart” (i.e., a list of items selected by a buyer via user device 120 to be purchased) so that the items may be gathered and readied for pickup by the user. The desired pickup location of the user may also be displayed in customer module 134. In embodiments of the present invention, potential pickup locations may include a store stock area, the parking lot, a local warehouse for the store and home delivery. Customer module 134 also allows the store personnel to verify that the payment transaction is complete and approved by the bank, credit union, credit card company or other financial institution prior to delivery of the purchased items to the user.

According to embodiments of the present invention, distribution server 140 includes user profile management 142, inventory management 144, and Next Generation Shopping (NGS) Program 146. Additionally, distribution server 140 includes functions (not shown) such as the following: store-to-store comparisons; inventory history; backup for store server 130; etc. In an alternative embodiment, user profile management 142, inventory management 144, and NGS Program 146 may be found on any other devices connected to network 110.

In one embodiment of the present invention, user profile management 142 is a program, subprogram of a larger program, application or plurality of applications which administers the various profiles of NGS Program 146 users. Aspects of a profile of a user of NGS Program 146 which are managed by user profile management 142 include the personal information (e.g., name, mailing address, e-mail address, user ID, password, credit card information, etc.) of the user, the complete transaction history of the user, a list of the top X items purchased by the user (where X may be five, ten, or any other number specified by either the user or the store), and the special offers tendered to the user, including whether offers were accepted. In various embodiments, user profile management 142 may also administer user login to NGS Program 146 by way of an authentication protocol. The protocol may require the user ID and password of the user, may request an answer to a pre-determined security question or questions, or may require some other form of authentication known to those skilled in the art.

In various embodiments, inventory management 144 is a program, subprogram, application or plurality of applications which manages store inventory. Functions administered by inventory management 144 include providing real-time product inventory counts, current inventory pricing, including normal and sale prices for items in the inventory, store-to-store inventory control, and re-ordering of product based on supply and demand. The real-time product inventory count is the actual, current inventory reduced by the amount of inventory in the virtual shopping carts of the users. For example, if there are currently one hundred units of product ‘A’ available in the stock room and three users are in the process of purchasing a combined total of twenty units, the real-time inventory of product ‘A’ is eighty units. In one embodiment, inventory management 144 may be a part of an overall inventory management system.

In an embodiment of the present invention, NGS Program 146 is a program, subprogram of a larger program, application or plurality of applications which provides a user with a method to simplify the next generation shopping experience. In one embodiment, NGS Program 146 includes a login component. This component allows a user to register an account for access to NGS Program 146. Once registered, the login component allows the user to log into NGS Program 146.

In another embodiment, NGS Program 146 includes a device management component. This component allows a user of user device 120 to know the status of the device or to adjust the properties of the device via user interface 122. For example, a battery life indicator may be displayed by the device management component. Also, the volume of user device 120 and the font size and brightness of the display (not shown) may be controlled via the device management component.

In yet another embodiment, NGS Program 146 includes a shopping component. Features of the shopping component include the budget for a user, the shopping list for a user, a method for selecting an item to be purchased, a repository for special offers, and a means for making a payment for the selected items. Each of these features will now be described in some detail. The budget aspect allows a user to perform tasks such as setting a spending limit for the current shopping trip and calculating a periodic (e.g., weekly, monthly, annual, etc.) budget for various categories of items (e.g., food, clothing, medical, automobile, vacation, etc.). The shopping list may include specific items to be purchased on a given shopping trip (e.g., milk and bread), a watch list of items to be purchased if a price threshold is met (e.g., two gallons of deck stain if the price drops below twenty dollars per gallon), and a wish list of items a user desires but may not need (e.g., a new pair of shoes for the office). The method for selecting an item to be placed in the virtual shopping cart (i.e., to be purchased) may include an imaging device (not shown) for scanning a barcode or quick response (QR) code, or for taking a photograph of an item and utilizing object recognition to identify the item. The method of selection may also include entering a product identifier, such as the product UPC (Universal Product Code), via keyboard, touchscreen or audio input. Once an item is selected, the user may input a quantity of the item to be purchased. The special offer repository may include previous special offers that have not expired and were not used during an earlier shopping trip, special offers based on previous purchases made with special offers, based on a current shopping list or based on current items in the shopping cart of the user which were not on the current shopping list, special offers based on membership in a retail store loyalty program or inventory management, and special offers from another retail store. The payment aspect provides a method for the user to pay for the items being purchased. For example, the user may choose to pay cash by interacting with store personnel, may opt to use a debit or credit card to pay for the items in the shopping cart or may select a worldwide online payment system as the method of payment. The payment transaction must be completed and approved before the user may receive the purchased items and a confirmation of delivery is sent.

NGS Program 146 allows a user to select items for purchase without actually taking that particular item off of the shelf at that moment in time. This allows the store to display only one item for each product in inventory. In an embodiment, when a purchase transaction is complete, store personnel collect the purchased items and package them for delivery to a location chosen by the user. This further allows a store to save money by paying for more stock space and less retail space.

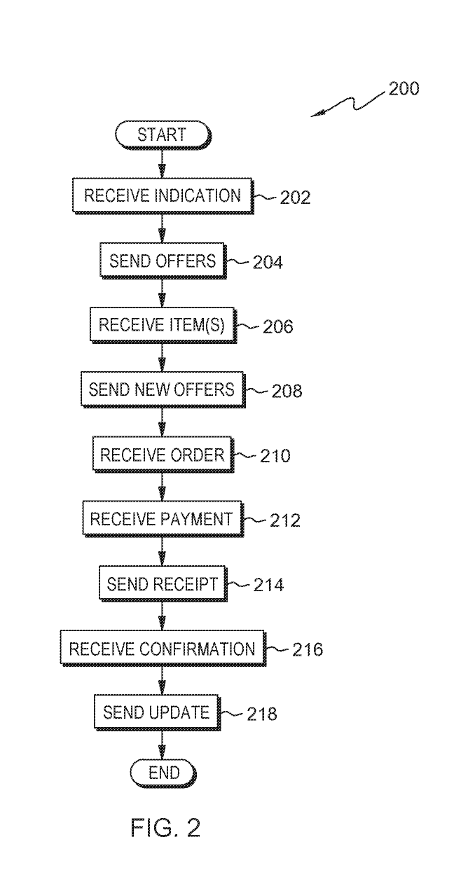

FIG. 2 is a flowchart depicting operational steps 200 of Next Generation Shopping (NGS) Program 146, on distribution server 140 within computing environment 100 of FIG. 1, a program that functions to simplify the next generation shopping experience, in accordance with an embodiment of the present invention. In one embodiment, NGS Program 146 performs the operational steps. In an alternative embodiment, any other program, while working with NGS Program 146, may perform the operational steps. In an embodiment, NGS Program 146 may invoke operational steps 200 upon the request of a user. In an alternative embodiment, NGS Program 146 may invoke operational steps 200 automatically upon determining a user has entered a retail store.

NGS Program 146 receives an indication (step 202). In other words, NGS Program 146 receives an indication that a user (i.e., a shopper) has initiated a login to NGS Program 146 and is awaiting authentication based on the credentials of the shopper. In an embodiment of the present invention, NGS Program 146 receives an indication from a shopper via user device 120. For example, a shopper enters a retail store and logs into NGS Program 146 via a user ID and password at which point NGS Program 146 will verify the credentials of the shopper. In another embodiment, NGS Program 146 receives an indication that a shopper has entered the retail store. In this embodiment, NGS Program 146 may recognize a registered user which enables NGS Program 146 to send special offers to the shopper based on previous purchases of the shopper. In yet another embodiment, NGS Program 146 may identify any user entering the store with NGS Program 146 on user device 120 and may send the user special offers based on any number of factors including inventory management, expiration date of certain inventory, previous purchases, etc. In yet another embodiment, NGS Program 146 may send special offers to users within a certain proximity (e.g., two hundred feet) of the store entrance; this may entice a user entering a different store to enter the store utilizing NGS Program 146.

NGS Program 146 sends offers (step 204). In other words, NGS Program 146 sends discount offers to the shopper based on the profile of the shopper (where the shopper specifies preferred items), the previous shopping history of the shopper and any loyalty programs where the shopper may be a member. For example, the shopper may indicate a preference for a specific brand so NGS Program 146 sends offers for that brand to the shopper. In another example, the shopper may purchase item ‘X’ every other week so in an attempt to entice the shopper to purchase item ‘X’ in the ‘off’ week, NGS Program 146 may send an discount coupon for item ‘X’ to the shopper. In yet another example, the shopper may receive, from NGS Program 146, a ten dollar gift card for every two hundred and fifty dollars spent in the store because the shopper is a member of the loyalty program of the store. In one embodiment, NGS Program 146 sends a coupon to user device 120 over network 110. For example, NGS Program 146 sends the shopper an offer for a free DVD (Digital Versatile Disc) if the shopper buys one additional DVD based on the previous purchases of nine other DVDs by the shopper. In another embodiment, NGS Program 146 may suggest a shopping list based on the previous shopping list of the shopper and may also provide offers based on the suggested shopping list. In yet another embodiment, NGS Program 146 may load the complete inventory of the store onto user device 120 for the benefit of the shopper. This would allow the shopper to select items directly from user device 120 rather than walking through the store to select items to be purchased.

NGS Program 146 receives items (step 206). In other words, NGS Program 146 receives an indication of items to be purchased by the shopper. In one embodiment, the shopper may select an item to be purchased by manually entering the UPC barcode of the item or scanning the UPC barcode or QR code using an image device (not shown) found on user device 120. In another embodiment, the shopper may select an item by taking a photograph of the item using the image device (not shown) found on user device 120 and using the photograph in conjunction with object recognition software to identify the item. Once an item in selected, an embodiment of the present invention allows the shopper to indicate the quantity to purchase. For example, the shopper may scan the UPC barcode for a DVD of a movie using a smartphone and may indicate a quantity of one to be purchased. NGS Program 146 may also allow the shopper to read product ratings and reviews for the item and to view price comparisons for the item at other stores within a pre-defined area (e.g., a specific radius from the current location of the shopper, within the same zip code, etc.). Price comparisons for the item may be provided from stores including at least one of stores in the same chain or stores owned by a competitor. NGS Program 146 may monitor the price comparisons and any reviews read by the shopper and may send a special offer based on real time analytics of the information (e.g., a better price for an item at a competitor) the shopper has been provided.

NGS Program 146 sends new offers (step 208). In other words, NGS Program 146 may send new offers while the shopper is selecting items to be purchased by placing them in a virtual shopping cart. In an embodiment of the present invention, NGS Program 146 may send new offers to user device 120 over network 110. The new offers may be based on at least one of the following: the current items being purchased by the shopper, inventory management within the store (e.g., an effort to move excess inventory or inventory that may be approaching an expiration date), or identical or substantially similar items being sold in another store where the other store may be in the same chain or may be a competitor. For example, NGS Program 146 may send a “buy two, get one free” offer on rye bread to the shopper because the shopper has already indicated the intent to purchase one loaf and a portion of the inventory of rye bread in the stock room is within four days of expiring while the norm for bread expiration is five days.

NGS Program 146 receives the order (step 210). In other words, NGS Program 146 receives an indication from the shopper that the shopper has finished adding items to the virtual shopping cart that the shopper intends to purchase, has submitted the order, and is ready to submit payment for the items in the order. In an embodiment, NGS Program 146 receives input from user device 120 over network 110. For example, the shopper indicates, via a smartphone, that the current shopping trip is complete with the purchase of two DVD movies and three loaves of rye bread.

NGS Program 146 receives payment (step 212). In other words, NGS Program 146 receives the indication of a payment from the shopper for the items being purchased and confirms the payment as valid. In various embodiments of the present invention, the method of payment may include at least one of the following: a cash, personal check, or gift card payment to one of the store personnel who in turn confirms the full payment in NGS Program 146, a credit or debit card payment which in turn is confirmed by the financial institution of the customer, or via a worldwide online payment system which verifies the payment to NGS Program 146 for the shopper. For example, the shopper uses a debit card and corresponding PIN (personal identification number) to complete the payment transaction for the DVDs and rye bread.

NGS Program 146 sends the receipt (step 214). In other words, NGS Program 146 sends the receipt for the purchased items to the shopper. In various embodiments, the receipt provided to the customer may be delivered via e-mail, as an SMS (short message service) message or as an MMS (multimedia messaging service) message. The receipt may also be provided to the stock room or warehouse so that store personnel may gather the purchased items. In another embodiment, as purchased items are collected for the shopper, NGS Program 146 verifies applicable product expiration date(s) based on a pre-defined threshold (i.e., the number of days between the current date and expiration date). For example, dairy items requiring refrigeration may only have a one day threshold while non-refrigerated bakery items may have a three day threshold. Products not meeting the threshold may not be sold to the shopper. In yet another embodiment, store personnel communicate with the shopper, via NGS Program 146, to determine where the items will be picked up or delivered. Possible locations include, but are not limited to: a pickup area designated by the store, the vehicle of the shopper, the home of the shopper, or any other location selected by the shopper. In an embodiment, NGS Program 146 may communicate with the vehicle of the shopper via the ‘Internet of Things’ (IoT) in order to determine the location of the vehicle. The IoT is a scenario in which objects are provided with unique identifiers as well as the ability to transfer data over a network without requiring human-to-human or human-to-computer interaction. IoT has evolved from the convergence of wireless technologies, micro-electromechanical systems (MEMS) and the Internet. Based on the selected location, NGS Program 146 will indicate when the order will be ready or when it will arrive at the location. In an embodiment of the present invention, NGS Program 146, on distribution server 140, sends the receipt for the purchased items to user device 120. For example, the receipt for the two DVDs and 3 loaves of rye bread are sent to the smartphone of the shopper. The shopper is also informed that the rye bread will expire in four days from the current date.

NGS Program 146 receives confirmation (step 216). In other words, NGS Program 146 receives confirmation from the store personnel that the order has been delivered to the preferred location of the shopper. In an embodiment of the present invention, a user acknowledges receipt of their items on user device 120 and NGS Program 146, on distribution server 140, receives the acknowledgement over network 110. For example, the shopper acknowledges receipt of their order at the store designated pickup location via their smartphone and NGS Program 146 receives that acknowledgement.

NGS Program 146 sends an update (step 218). In other words, NGS Program 146 updates the store inventory based on the completed transaction. In an embodiment of the present invention, NGS Program 146 interacts with inventory management 144 on distribution server 140. For example, NGS Program 146 decrements the DVD inventory by two units (based on the purchased titles) and the rye bread inventory by three units. In other embodiments, NGS Program 146 may be integrated with inventory management modules of other stores in order to manage inventory in a wider area and NGS Program 146 may recommend pricing adjustments (increases or decreases) based on sales, aged inventory, or other product information (e.g., a new version of a product announced). In another embodiment, NGS Program 146 may use the preferences of multiple customers to manage inventory. For example, in addition to an increased inventory at Spring for swimming suits, NGS Program 146 may learn that there is a slight increase in demand for swimming suits in late Fall due to people taking Winter vacations in a warmer climate; consequently, NGS Program 146 may suggest ordering additional swimsuits to inventory management 144 to cover the increased demand.

In an embodiment of the present invention, NGS Program 146 provides a consistent experience across multiple stores, regardless of whether the stores belong to the same chain (e.g., Store ‘X’, Eastside location versus Store ‘X’, Westside location), are different stores of the same type (e.g., clothing store ‘A’ versus clothing store ‘B’), or are totally different types of stores (e.g., a grocery store versus an electronics store).

In another embodiment of the present invention, the entire process as described above may be completed as a purchase done via the internet. The shopper may log into NGS Program 146 via web portal 132, may receive offers based on the past history of the shopper, may select items to purchase, may receive additional offers based on the current shopping cart of the shopper, may submit the completed order, may pay for the completed order, may be given a receipt for the completed order, may receive confirmation that the order has been gathered and shipped to the preferred location of the shopper and finally, NGS Program 146 may perform the inventory updates based on the completed order.

FIG. 3 depicts computer system 300 which is an example of a system that includes Next Generation Shopping (NGS) Program 146. Computer system 300 includes processors 301, cache 303, memory 302, persistent storage 305, communications unit 307, input/output (I/O) interface(s) 306 and communications fabric 304. Communications fabric 304 provides communications between cache 303, memory 302, persistent storage 305, communications unit 307, and input/output (I/O) interface(s) 306. Communications fabric 304 can be implemented with any architecture designed for passing data and/or control information between processors (such as microprocessors, communications and network processors, etc.), system memory, peripheral devices, and any other hardware components within a system. For example, communications fabric 304 can be implemented with one or more buses or a crossbar switch.

Memory 302 and persistent storage 305 are computer readable storage media. In this embodiment, memory 302 includes random access memory (RAM). In general, memory 302 can include any suitable volatile or non-volatile computer readable storage media. Cache 303 is a fast memory that enhances the performance of processors 301 by holding recently accessed data, and data near recently accessed data, from memory 302.

Program instructions and data used to practice embodiments of the present invention may be stored in persistent storage 305 and in memory 302 for execution by one or more of the respective processors 301 via cache 303. In an embodiment, persistent storage 305 includes a magnetic hard disk drive. Alternatively, or in addition to a magnetic hard disk drive, persistent storage 305 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 305 may also be removable. For example, a removable hard drive may be used for persistent storage 305. Other examples include optical and magnetic disks, thumb drives, and smart cards that are inserted into a drive for transfer onto another computer readable storage medium that is also part of persistent storage 305.

Communications unit 307, in these examples, provides for communications with other data processing systems or devices. In these examples, communications unit 307 includes one or more network interface cards. Communications unit 307 may provide communications through the use of either or both physical and wireless communications links. Program instructions and data used to practice embodiments of the present invention may be downloaded to persistent storage 305 through communications unit 307.

I/O interface(s) 306 allows for input and output of data with other devices that may be connected to each computer system. For example, I/O interface 306 may provide a connection to external devices 308 such as a keyboard, keypad, a touch screen, and/or some other suitable input device. External devices 308 can also include portable computer readable storage media such as, for example, thumb drives, portable optical or magnetic disks, and memory cards. Software and data used to practice embodiments of the present invention can be stored on such portable computer readable storage media and can be loaded onto persistent storage 305 via I/O interface(s) 306. I/O interface(s) 306 also connect to display 309.

Display 309 provides a mechanism to display data to a user and may be, for example, a computer monitor.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disc (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for shopping, the method comprising:
receiving, by one or more computer processors, an indication of a user, wherein the indication of the user includes an indication that the user is within a pre-determined proximity of a retail store and that the user has entered the retail store and logged into a program;
sending, by one or more computer processors, a special offer to the user, wherein the special offer includes a special offer based on a past purchase history of the user and a current shopping list of the user;
receiving, by one or more computer processors, an indication from the user of an item being placed in a virtual shopping cart, wherein the indication is from an image device of the user, wherein the indication includes quick response (QR) code information, wherein the user is able to read product ratings, reviews and price comparisons from one or more other stores for the item being placed in the virtual shopping cart, and wherein the one or more other stores may be stores in a same chain as the retail store or one or more competitors to the retail store;
receiving, by one or more computer processors, an indication from the user of a quantity of the item;
receiving, by one or more computer processors, an indication from the user that no additional items will be added to the virtual shopping cart, wherein at least one item in the virtual shopping cart includes an acceptance of the special offer;
receiving, by one or more computer processors, a payment from the user for a completed order, wherein the completed order is comprised of the items added to the virtual shopping cart;
responsive to confirming payment for the completed order, sending, by one or more computer processors, a receipt for the completed order, wherein the receipt for the completed order is sent to the user;
sending, by one or more computer processors, an indication to retrieve the completed order; and
sending, by one or more computer processors, an update to an inventory management system based on the completed order; wherein the inventory management system is associated with the retail store in order to manage inventory of the retail store, and wherein the inventory management system is also associated with one or more other retail stores in order to manage inventory in the one or more other retail stores and to recommend pricing adjustments for the retail store and the one or more other retail stores.
